(19) United States
(12) Patent Application Publication
(10) Pub. No.: US 2014/0282005 A1
(43) Pub. Date: Sep. 18, 2014

(54) Apparatus for message triage

(71) Applicant: Howard Gutowitz, New York, NY (US)

(72) Inventor: Howard Gutowitz, New York, NY (US)

(21) Appl. No.: 13/844,389

(22) Filed: Mar. 15, 2013

(51) Int. Cl. H04L 12/58; G06F 3/0488; G06F 3/0487; G06F 3/16

(52) U.S. Cl. CPC H04L 51/14; G06F 3/167; G06F 3/0488; G06F 3/0487
USPC 715/728; 715/752; 715/781

(57) ABSTRACT

Incoming messages, like incoming wounded on the battlefield, can be initially sorted into groups e.g. a) those which can be or should be treated immediately, b) those which can be treated later, and c) those which should not be treated. Like in a triage unit on a battlefield, it is useful to reduce the amount of effort and increase the speed at which this sort takes place. The present invention allows the user's effort to sort to be reduced to a minimum, with a consequent increase in speed.

### RELATED APPLICATIONS

This application is a continuation in part of U.S. application Ser. No. 13/744,008 hereby incorporated by reference in its entirety and relied upon, which in turn claims the benefit of priority under 35 U.S.C. §119(e) to U.S. Provisional Patent Application Ser. No. 61/587,152, filed on Jan. 17, 2012, the benefit of priority of which is claimed hereby, and which is incorporated by reference herein in its entirety and relied upon. It also hereby claims the benefit of priority from U.S. application Ser. No. 13/384,314 which is the US National Phase of international application PCT/US10/41979 with priority date Jul. 14, 2009, all of which are incorporated by reference herein in their entirety and relied upon.

### FIELD OF INVENTION

This invention relates generally to devices capable of triaging a stream of incoming messages into sub-streams according to the future treatment intended by the user for each message.

### BACKGROUND OF THE INVENTION

The typical knowledge worker is drowning in information, constantly overloaded with incoming messages, of all types, many demanding some sort of response. In the case of email messages, for example, the problem may become so acute for users of the prior art that they declare “email bankruptcy” http://techcrunch.com/2008/03/23/a-crisis-in-communication/ by simply deleting all of their incoming email, much of it not even opened. The phenomenon of email bankruptcy highlights the failure of the prior art to provide the level of high-volume, high-speed message triage needed by modern society. That this need has yet to be satisfied by the prior art proves that any workable technical solution must be highly unobvious.

### Difficulty Measure

As an aid in particularly pointing out some features of the various embodiments of the present invention, we will adopt a measure of the difficulty for the typical user to complete a task using a user interface (UI), which we will call the difficulty measure. The difficulty measure is a pair of integers, (x,y) where x counts the number of manual gestures needed to be performed in the course of the task, and y counts the number of selections from a group or list of closely related, closely separated items needed to be performed in the course of the task. Selection difficulty has two sources, in general. First, selecting one item from a list or group of related items entails a cognitive and perceptual load. The user must comprehend and mentally register each of the items in the list to know which is the one they want to select. For instance, in the case of selecting a single message from a list of messages, the user must read each of the messages, at least in part, to know which is which. Second, there is the mechanical difficult of targeting the desired message with a gesture. The smaller the display of each item, and the more closely they are arrayed together, the harder it is to hit a single item accurately. The difficulty of selection is compounded when the list or group is so big that not all items can displayed at the same time. In that case additional gestures are required to scan the list or group, and additional cognitive and perceptual load is placed on the user who must devise and execute strategies to find the desired item. Thus it is clear that selection is a task of potentially unbounded complexity, and that giving its difficulty a single numerical value is a potentially large simplification. Thus the difficulty measure, as used in this disclosure, is but a general descriptive tool which is brought forth merely to help illustrate and explain certain features and aspects of the present invention, which can also be readily understood without any reference to such difficulty measures.

The difficulty measure as described above is a partial ordering of the difficulty of tasks and can be converted as required, with a further loss of precision, into a single numerical value supplying an ordering: the total difficulty. Total difficulty is defined as x+2y for the corresponding difficulty measure values. It will be appreciated that total difficulty provides but a general indication of the actual difficulty of a task, and is useful mainly as a way of comparing fairly similar systems.

We will exclude typing gestures from the count of manual gestures when typing text is part of the task. We will similarly exclude confirmation gestures—those gestures whose sole purpose is to confirm the user's intent when another gesture is performed—since the difficulty of any task can be inflated with an arbitrary number of confirmation gestures. For the present purposes, taps and uninterrupted continuous swipes are each considered to be a single gesture.

By “group or list of closely related items” from which “selections” are performed we mean items which could be easily confused, especially by persons of low visual or manual acuity and/or require non-trivial mental computation to distinguish. For instance, a row of several icons close to each other would be such a group or list, but two icons isolated on opposite sides of a typical handheld device would not be. Two vector swipe gestures which differ from each other by only a small angle would be such a list or group, but two vector swipe gestures in opposite directions would not be. A menu (with more than one menu item), such as commonly found in computer user interfaces is a list requiring a selection by this definition. A scrollable table with multiple items clearly requires “selection” in the sense of this disclosure. Two UI elements will be considered physically “close” if their center-to-center distance is less than the width of an average adult male thumb, or otherwise requiring fractional-thumb-width manual acuity.

The difficulty of selection in a list general depends on the number of items in the list, and the position of the item to be selected in the list (where extreme elements are easier than otherwise similar interior elements). The difficulty measure as defined here could be refined to take dependencies of this sort into account, but for present purposes we will consider all selections from a list to count equally. Similarly, the difficulty of selection between close, similar UI elements, can be more precisely and continuously modeled using Fitts' law and extensions thereto, but for present illustrative, non-limiting purposes the “rule of thumb” adopted above will suffice. We note that this definition of difficulty measure assumes that the user interface is operated manually under visual guidance. An otherwise similar UI could also be operated by voice or some other means. Operated non-manually or non-visually, the difficulty measure would need to be modified to adequately capture the cognitive load involved in verbal gestures and selections.

Finally, hardware support for the UI is assumed to be sufficient to recognize the gestures mentioned. For example, if a swipe gesture is mentioned, the hardware is assumed to be such to support the recognition of swipes, such as a capacitive touch screen. Typically, when the detailed description of an embodiment, for illustrative purposes, mentions a physical UI interaction, e.g. swipes, a similar UI could be built in different hardware using, rather, taps on buttons or some other electro-mechanical gesture recognition hardware, or could be performed using voice recognition. Indeed, for the sake of clarity of exposition, we will often use the term “button” to refer to a gesture-sensitive region, with the understanding that the region might be activated by a tap, swipe, or some other gesture, depending on details of hardware and implementation.

Note that the difficult of invoking a function by means of non-mechanical input, e.g. by a voice command, may or may not be the same as the difficulty of invoking the same function by means of mechanical gestures such as swipes or taps. Nonetheless, it may be anticipated that when a given function can be invoked by either voice or mechanical gestures in a given interface, the voice difficult measure and the mechanical difficult measure will be related. For instance, in the case of selection from a list, the list may need to be scanned to find the required selection, which scanning may be a function of the size of the list in the case of either voice or mechanical gesture. Even if a random-access voice mechanism is provided, the length of the list will impact cognitive load, and thus access time and difficulty.

### BRIEF DESCRIPTION OF THE DRAWINGS

FIG. 1A Illustrative calculation of the difficulty measure for a prior art system.

FIG. 1B Illustrative calculation of the difficulty measure for an aspect of an embodiment of the present invention.

FIG. 2A An alternate embodiment using swipes.

FIG. 2B An alternative embodiment using taps.

FIG. 3 Adding mailboxes, example 1.

FIG. 4 Adding mailboxes, example 2.

FIG. 5 Illustrative embodiment for extended triage, UI aspects, including illustrative perpendicular duplication.

FIG. 6 Illustrative embodiment for extended triage, mailbox management aspects.

FIG. 7A Swipes with a confirmation tap: the swipe.

FIG. 7B Swipes with a confirmation tap: the confirmation tap.

FIG. 8A Swipe confirm in a table: the swipe.

FIG. 8B Swipe confirm in a table: the confirmation tap.

FIG. 9A Moving messages between triage mailboxes.

FIG. 9B Moving messages between triage mailboxes, including todo and calendar mailboxes.

FIG. 10A Triage in a client-server setting: with no feedback from client to server.

FIG. 10B Triage in a client-server setting: with feedback from client to server.

FIG. 11 A prior-art device with buttons in the thumb-inaccessible region which are not duplicated to the thumb-accessible region.

FIG. 12 Schematic representation of thumb-inaccessible and thumb-accessible regions for an illustrative device.

FIG. 13 Illustrative duplication of the function activated by a gesture in the thumb-inaccessible region to a gesture in the thumb-accessible region activating the same function.

FIG. 14 Another illustrative duplication of the function activated by a gesture in the thumb-inaccessible region to a gesture in the thumb-accessible region activating the same function.

FIG. 15 Illustrative duplication of the function activated by a gesture in the thumb-inaccessible region to a gesture in a thumb-accessible function tray activating the same function.

FIG. 16A Illustrative configuration of a thumb-accessible function tray in a horizontal orientation, but not at the bottom.

FIG. 16B Illustrative configuration of a thumb-accessible function tray oriented vertically, and broken into two parts.

FIG. 16C Illustrative configuration of a thumb-accessible function tray represented as two ovals.

FIG. 17A Illustrative labeling mechanism for a thumb-accessible function tray supporting both swipes and taps, with a button displayed.

FIG. 17B Illustrative labeling mechanism for a thumb-accessible function tray supporting both swipes and taps, with a button display suppressed.

FIG. 18A Illustrative order-preserving duplication of functions activated by gestures in the thumb-inaccessible region to gestures in the thumb-accessible region activating the same functions, with horizontal order preservation.

FIG. 18B Illustrative order-preserving duplication of functions activated by gestures in the thumb-inaccessible region to gestures in the thumb accessible region activating the same functions, with vertical order preservation.

FIG. 19 A swipe switch associated to a tappable area in a function tray, which tappable area shares a function with the swipe switch.

FIG. 20 An array of swipe switches, a plurality of which is associated to a tappable area in a function tray, and each member of the plurality thus associated shares a function with its associated tappable area.

FIG. 21 The array of FIG. 20 in which the association of a given swipe switch to a given tappable area in a function tray is visually marked.

FIG. 22 The embodiment of FIG. 21 in which the function tray is hidden.

FIG. 23A An independent function tray in a first resting state.

FIG. 23B An independent function tray in a transitional state.

FIG. 23C An independent function tray in a second resting state.

FIG. 24 A smart bezel associated to a keyboard.

FIG. 25 A smart bezel associated to a function tray.

FIG. 26 A smart bezel associated to both a keyboard and a function tray.

### ILLUSTRATIVE CALCULATION OF THE DIFFICULTY MEASURE

Turning now to FIGS. 1A-B, we see a comparison between an illustrative embodiment of a user interface of the present invention and the user interface of a representative prior art system. The prior art system is the mail.app program supplied with the Apple® iOS5® operating system for mobile devices, for sending and receiving emails as embodied in the iPhone®. The prior art system is presented in FIG. 1A as a sequence of panels schematically representing various states of the system when used to select and respond to an message. Aspects of an illustrative user interface of an embodiment of the present invention is presented in FIG. 1B, likewise as a sequence schematic panels representing various states of the system when used to select and respond to an message. This comparison will include the computation of the difficulty measure for each system.

In the prior art system of FIG. 1A, at panel [100], a list of message previews is presented in a table. A message is chosen from the table by tapping on the desired message preview [101]. In the computation of the difficulty measure, this selection counts as one manual gesture. It will also count as selection, since the selection is made from a table of contiguous, similar items in view, so the partially computed difficulty measure is now (1,1). At panel [102] the body of chosen message is more fully revealed as a singleton item. To reply to the message, the user taps one of the buttons at the bottom of the panel [103]. This tap counts as a gesture, and also counts as a selection, since the array is composed of small, close-together buttons, so the partial difficulty measure is now (2,2). Note that the array of buttons contains 5 buttons, in a screen which is only 2 inches wide, so each button is separated from another by 0.4 inches, much less than the width of a typical adult human thumb. The tap [103] brings up a second array of buttons, shown in panel [104]. Another tap on one of the buttons [105] is required, as well as another selection from a list of closely spaced items, bringing the partial difficulty measure to (3,3). At panel [106], the user types their message, and taps another button [107], to send the message. Since the tap [107] is on a button relatively distant from other buttons (much greater than the width of a thumb), this action counts as a gesture, but not a selection, bringing the partial difficulty measure to (4,3). At panel [108], the user taps yet another isolated button [109] to bring the system back to a state at which a next message can be replied to, for a final difficulty measure of (5,3), and total difficulty of 11 (5+2*3).

To facilitate comparison to FIG. 1B, the sequence of panels is continued as the user begins to reply to another message: in panel [110], at [111] the user selects a different message from the list, the body of which is more fully displayed in panel [112].

Turning now to FIG. 1B, we compute the difficulty measure for replying to a message in the given illustrative embodiment of the present invention. At panel [114], the preview size is adjusted so that a single message is displayed, filling the screen, rather than several messages displayed at a time as in panels [100] and [110] of FIG. 1A. A tap on an isolated button at [113] begins the process of replying to the message, for a partial difficulty measure of (1,0). Panel [116] corresponds to panel [106] of FIG. 1A, in that this is where the user types their response. In panel [116], the user swipes the bottom bar [115], to send the message, or taps an isolated button in the lower left or right-hand corner. The bottom bar is not part of an array or list of small, similar objects, and neither is the isolated button, so the difficulty measure is (2,0). This is the final difficulty measure for reply, since upon making the swipe, or tapping the button, the system returns to message preview display, with the next message loaded in the display, ready to be replied to, and fully completing the cycle. This corresponds to the panel [112] of FIG. 1A. In summary, this illustrative embodiment had a difficulty measure (2,0) (total difficulty 2) which is much less than the difficulty measure (5,3) (total difficulty 11) of the illustrative prior art system. Other embodiments of the present invention, and other prior art systems, can be analyzed in the same way.

In the examples of FIGS. 1A-B, forwarding a message is accomplished with the same difficulty measure as replying to a message. The only difference is in which button is pressed. Namely, if button [125] is pressed in FIG. 1A rather than button [105] then the message is forwarded rather than replied to, and in FIG. 1B, if button [123] is pressed rather than button [113], then the messages is forwarded rather than replied to when the forwarding address is typed in panel [106] for the prior art system, or when the forwarding address is typed in panel [116] in the illustrative UI for the present embodiment. Thus for forwarding a message also, the total difficulty comparison is 11 for the prior art system and 2 for the present embodiment described in FIG. 1B.

Without elaborating a difficulty measure for voice commands adopted for the devices of FIGS. 1A-B, we note that only 3 panels are required to describe a cycle of replying to or forwarding a message in the present embodiment, whereas 7 are required to describe a cycle in the prior-art system. However implemented, a voice driven system based on the prior art would need to make more transitions and thus have higher difficulty than the present embodiment were it to be voice driven in the same way, notably since there are more selections, but also more gestures.

### Alternate Embodiment Using Only Swipes to Forward or Reply

To stress that embodiments of this invention may be built with hardware responsive to various kinds of gestures, we will now consider two variants of forwarding and replying, one in which swipes are used to perform four basic functions, and another in which the same basic functions are accomplished using buttons. We have already seen in FIG. 1B an embodiment using a mixture of swipes and buttons, and discussed how the same embodiment could be driven by voice. How these or other gestures are assigned to hardware will depend on the sensitivity of the available hardware to the various gestures, among other factors. Voice activation requires appropriate hardware and software. Though a number of embodiments presented in this detailed disclosure illustratively use the property of hardware such as capacitive touch screens to respond to swipes, most embodiments can also be built with lower-cost hardware, such as traditional hardware keyboards or resistive touch screens.

Turning now to FIG. 2A, we see an illustrative embodiment in which four functions are performed using swipes, namely 1) going forward in a message list, 2) going backwards in a message list, 3) replying to a message, and 4) forwarding a message. In FIG. 2A, arrows represent the direction of swipes, so functions 1)-4) are illustratively performed by the swipes [201]-[204] respectively. In FIG. 2B the same four functions 1)-4) are performed by tapping the buttons [205]-[208] respectively. It is to be noted that these four swipes are very different from each other, and thus not easily confused, which results in low difficulty measure. It will be appreciated that a different assignment of functions to swipes or buttons is within the scope of this embodiment.

### Adding Mailboxes

### Example 1

We have shown that in aspects of the present invention certain message-manipulation functions, such as reply and forward, can be accomplished with very low difficulty measure. The next set of embodiments build on that discovery to provide a way to very quickly and easily sort incoming messages into bins. These bins will be referred to as mailboxes, though it is understood that the term “messages” might refer to any sort of data which a human user can comprehend, such as text in the form of e.g. email, instant messages, SMS, tweets and the like, and/or images, and/or sounds, and/or smells, and/or vibrations etc.

We now describe an illustrative embodiment in reference to FIG. 3. In this embodiment, messages can be moved into various mailboxes following various low difficulty measure actions. Once moved, the messages are removed from the incoming queue of messages (the “Inbox”), and thus “triaged” in terms of the present disclosure. Turning now to FIG. 3, we see a system comprising three mailboxes, illustratively designated Inbox [300], Sent [301], and Responded [302]. In the embodiment of FIG. 3, the user may perform one of two actions on an incoming messages, either reply or forward, both of these being a “response”. For the sake of illustration, we will assume that a user interface similar to that of FIG. 1B is used for these actions. First, a message is shown in the message viewer as shown in FIG. 1B, panel [114]. When the message in Inbox [300] is responded to, the original message is moved to the “Responded” [301] mailbox for archiving, while the message as modified by including the text of the response is placed in Sent [301] mailbox, and the original message is removed from the Inbox [300] mailbox. The difficulty measure of this action (given the UI of FIG. 1B) is shown in FIG. 3 [304] as a label on the arrow indicating the action performed. When this action is completed, a new message from the incoming message queue is shown in the message viewer, as shown in panel [118] of FIG. 1B, permitting this new message to then be replied to or forwarded in turn. If a message is forwarded rather than replied to, then the message is moved in its original form from the Inbox [300] mailbox to the Responded [302] mailbox, while the message, together with the address to which it was forwarded is moved to the Sent [301] mailbox. Variants of this message-management scheme should be evident, such as not placing the message in the Sent [301] upon forwarding, but only in Responded [302], perhaps together with the forwarding address and other data related to the forwarding, such as the time of forwarding, or even leaving one or the other of Sent [301] or Responded [302] mailboxes out of the system.

### Adding Mailboxes

### Example 2

Another simple sort of triage is one in which incoming messages are either deleted or moved to another mailbox for later further treatment, or simply archiving. Such a system will now be presented as a further illustrative use of mailboxes to systematically sort an incoming queue of messages into sub queues (“triage” in the terms of the present disclosure). Turning now to FIG. 4, we see an illustrative system comprising three mailboxes Inbox [400], Trash [401] and Later [402]. For the sake of illustration, we will assume that this mechanism is driven by a user interface similar to FIG. 2A, responsive to two swipes over the face of the current message. A swipe to the left in the UI causes the message to move along path [403] where the message in Inbox mailbox [400] is moved to the Trash mailbox [401], a swipe to the right in the UI causes the message to move along path [404] where the message is moved from the Inbox mailbox [400] to the Later mailbox [402] and removed from the Inbox [400]. The difficulty measure of each of these swipes is shown labeling the path [403] or [404], having adopted the user interface of FIG. 2A for illustration. Each move, from Inbox [400] to Trash [401] or Later [402] is accomplished with a single swipe, the two swipes completely distinct and difficult to confuse one with the other. Preferably, once a mail has been moved from Inbox [400] to Trash [401] or Later [402], it is removed from view in the interface of FIG. 2A, to be replaced with the next message in the Inbox [400] queue, completing one cycle of triage.

### Embodiment for Extended Triage

A more extensive triage system is now presented which illustratively combines elements of the embodiments of FIGS. 3-4 described above. The embodiment has both a user interface aspect, which will be discussed in reference to FIG. 5, and a mailbox management aspect, which will be described in reference to FIG. 6.

Turning now to FIG. 5, we see an example of a user interface suitable for performing the actions to be more fully described in reference to FIG. 6. In this system, messages from the incoming queue are displayed in the message viewer portion [500] of a screen. The message can be treated in various ways. The possible treatments in this embodiment are 1) move to Trash, 2) move to Later, 3) Reply, 4) Forward. Messages are removed from the incoming queue as they are treated. When treatments are performed scrupulously, the messages are treated in order. However, illustratively, the user may avoid performing any treatment of a message, by simply scrolling to the next message in the queue of incoming messages, or scrolling back to some other non-treated message. In an alternate embodiment, the user could be forced to treat each message before being able to view another one. Since the difficulty of treatment (the difficulty measure of the gestures involved) is so low, it might behoove even an impatient triager to deal with each message in order rather than skip around in the incoming queue.

In FIG. 5, the four treatments, as well as back and forth scrolling are illustratively mapped to gestures and user interface elements as follows: 1) move to Trash—a swipe to the left [504]; 2) move to Later—a swipe to the right [503]; 3) Reply—a button press, either [506] or [507]; 4) Forward—a button press either [505] or [508]; show previous message—a swipe downwards [501]; show subsequent message—a swipe upwards [502]. Note that two buttons, one near the top of the device [506] and one near the bottom of the device [507] perform the same action in this embodiment (reply to a message). Similarly, two buttons, one near the top of the device [505] and another near the bottom of the device [508] perform the same action in this embodiment (forward a message). This aspect will be more fully described in a later section of this disclosure.

### Mailbox Management

Mailbox management for the illustrative embodiment whose user interface is described in reference to FIG. 5 is now presented in reference to FIG. 6. FIG. 6 provides an overview of the change in disposition of messages after the actions described in reference to FIG. 5. Namely, when a message is replied to (using [506] or [507]) the original message is moved to the Responded mailbox [602], and the original messaged as modified by the response is moved to the Sent mailbox [601]. The gesture causing the message to follow the path [605] has difficulty measure (2,0), as shown in FIG. 6. Messages which are forwarded follow the same path [605]: the original message being moved from Inbox [600] to Responded [602], and the message together with its forwarding addresses, time stamp, and other information related to the forwarding event, is moved from Inbox [600] to Sent [601]. A message follows the path [606] upon the swipe action [504] of FIG. 5. The message moves from Inbox [600] to Trash [603]. The corresponding gesture has difficulty measure (1,0) as indicated in FIG. 6. Similarly, a message follows path [607] from Inbox [600] to Later [604] when gesture [503] of FIG. 5 is performed.

To summarize this embodiment: with a difficulty measure of no more than (2,0) for any action, messages can be rapidly triaged into three groups for a) quick treatment and release (Sent, Responded) b) non urgent care (Later) and c) abandonment (Trash), clearing the incoming message queue for still further messages. Meanwhile, preferably, no information is lost, and all of the messages remain available for subsequent review in the destination mailboxes. Otherwise said, In this embodiment, with a difficulty measure of no more than (2,0) to complete any triaging action, said triaging actions comprising replying, deleting and saving for later, messages can be rapidly triaged into queues comprising three said queues q1, q2, and q3, said messages being automatically moved to said q1 after being replied to while in q0, the queue of incoming messages. q2 is designated as a said queue for said messages which are to be archived or subject to further treatment, said messages moving from said q0 to said q2 as the result of a moving gesture, and said q3 designated as a said queue for messages to be deleted or otherwise abandoned, said messages moving from said queue q0 to said queue q3 as the result of a said moving gesture.

Swipes with a Confirmation Tap

In some instances, especially for novice users, it may be desirable to add a confirmation tap to certain swipe gestures. Therefore, according to one preferable aspect of this invention, swipe confirmations are available to novice users, and can be turned off for expert users. In the swipe embodiments presented up to now, the expert mode was disclosed. In a further desirable aspect, hardware aspects permitting, the confirmation tap is allowed to be received over a large area, up to the entire display surface. Turning now to FIG. 7, we see a swipe [700] performing some action, such as moving the shown message to the Later mailbox. Upon receipt of the swipe signal [700], the hardware displays a confirmation button [701] labeled “Later”, indicating that the message will be moved to the Later mailbox when the button is tapped; it occupies a large portion of the display, in this example, the same area previously occupied by display of the message text. If the swipe action was made by mistake, the confirmation button could be dismissed by another swipe anywhere in the area occupied by the confirmation button [701].

### Swipe Confirm in a Table

Especially when the item to be swiped is part of a table, or otherwise occupies a limited portion of the screen, it is desirable for the confirmation button to occupy substantially all of that same limited portion of the screen. An illustrative example is shown in FIG. 8. In FIG. 8A, a swipe [800] is performed in one cell of a table [801]. Upon the swipe [800], the cell of the table [801] is filled with a confirmation button [802], as shown in FIG. 8B. In this case, if the confirmation button [802] is pressed, the message will be moved to the Inbox mailbox. Just as in FIG. 7, if the confirmation button is pressed in error, it can be dismissed with another swipe somewhere in the button.

### Moving Messages Between Triage Mailboxes

Through discussion of the various illustrative embodiments above, we have particularly pointed out how untriaged message in an incoming queue can be operated on and then moved to other secondary mailboxes, or simply moved to other secondary mailboxes, using simple gestures such as swipes or button presses, in a novel process which we call triage. We now expand on those teachings to show that, similarly, triaged messages can be moved between secondary mailboxes, or even back to the primary mailbox, for potential re-triage. Indeed, mailboxes can be linked in networks of arbitrarily complexity according to these teachings, such that moves along any arc of the graph of the network can be accomplished with low difficulty measure. A network topology based on a particular inventive insight will now be described in reference to FIG. 9. In FIG. 9A messages in every mailbox, both primary and secondary, can be moved to at least two other mailboxes. The user interface for these movements could for example be one of those described in detail previously, such as a swipe in one direction to move a message to a first other mailbox, and a swipe in the opposite direction to move to a second other mailbox. In the case of the embodiment of FIG. 9A, one of the destination mailboxes for each of the secondary mailboxes is the primary mailbox, labelled Inbox [900]. This provides an “undo” mechanism, allowing triage errors to be corrected at least in part. The undo mechanism thus consists of path [920-923], which reverse the moves along paths [905-907]. Messages in the secondary mailboxes illustratively named Sent [901], Responded [902], and Later [904] can also be moved to Trash [903]. This “housekeeping” mechanism comprises paths [910-912]. Subsequently, from Trash [903] messages can be moved along path [913] to a terminal node [908] where they are permanently destroyed, completing the housekeeping. Thus, in this illustrative embodiment, every message has a path from Inbox [900] to a final disposition at the terminal node [908], regardless of how it is initially triaged. Note that all paths involving movement only (not forwarding or reply) are traversed as a result of gestures having a difficulty measure of (1,0).

### Expanded Mailbox Network

Turning now to FIG. 9B, we present an embodiment which further illustrates that the topology of the mailbox network can be expanded while still maintaining low difficulty measure for movement of messages across many nodes. The embodiment of FIG. 9B adds some task-management capabilities to the embodiment of FIG. 9A. That is, the embodiment of FIG. 9B contains all of the elements of FIG. 9A, and further comprises two more mailboxes Todo [930] and Calendar [931], for messages containing task descriptions, and messages containing dated items respectively. Each mailbox may be augmented with a mechanism to extract the relevant task or event data from the messages, and to format, display, and otherwise manage the data appropriately. E.g. Todo [930] might be associated with a mechanism to present each item in a check list, and Calendar [931] might present the data as named events arrayed by the days, weeks, and months of their occurrence. In the embodiment of FIG. 9B, messages arrive in mailboxes [930] and [931] from Later [904] via paths [940] and [941] respectively. Each of these paths have, illustratively, difficulty measure (1,0) as they are performed by a low difficulty measure actions, such as those illustratively available in the user interface embodiments of FIG. 2 or FIG. 5. Each of the paths [940] and [941] correspond to reverse paths back to Later [904], namely [950] and [951], again of difficulty measure (1,0). Finally, like the mailboxes Sent [901], Responded [902] and Later [904], mailboxes Todo [930] and Calendar [931] also have a low difficulty measure path to Trash [903], namely paths [960] and [961] respectively.

Having now benefited from the teachings of the embodiments described in detail above, a person skilled in the art has achieved a new vantage point, from which it can be appreciated that other mailbox relationships are well within the scope of this invention. E.g. while FIG. 9 presents only two mailboxes with more than two outwards paths (Inbox [900], and Later [904]), several or all mailboxes could have more than two outwards paths. While the network of FIG. 9A consistently provides reverse paths and paths to a terminal node, these desirable properties need not be found in all embodiments. It is also clear that, though an emphasis of the description of this embodiment has been to point out the low difficulty measure paths, paths with higher difficulty measure could be included as well. It should be further evident that additional machinery for managing and displaying messages could be built upon such a mailbox network. We have already mentioned todo list and calendar managers, and also point out that derived mailboxes could be created by search. E.g. a derived mailbox might contain all messages in any of the networked mailboxes which contain certain keywords, were sent within a certain date range, or have other specifiable properties, content or metadata. In general, a device according to this embodiment could comprise a gesture-sensitive area, such that when messages in a given said queue are being viewed by a user of said device, said gesture-sensitive area is capable of activating the movement of a message from said given queue to any other of said queues.

### Triage and Client-Server Interactions

Up to now, we have focused on describing in detail the triage apparatus itself, its machinery for the management of messages and its associated user interface; client hardware and software. However, said client hardware and software work in the context of a larger system, involving interactions with a exterior, perhaps distant, supplier of messages to the input queue of the client, said supplier of messages will be referred to as a server. The server may be a simple “fire hose” transmitting messages to one or more clients, with no opportunity for feedback from the client or clients to that server or any other server. In another extreme, server and client(s) may attempt to be exactly synchronized, such that any movement or modification of messages on the client is mirrored in a movement or modification of messages in the server. These two extremes are illustrated in FIG. 10. In more detail, FIG. 10A shows a repository of messages [1000] on a message server. The server has a transceiver [1001] which is capable of transmitting messages from the repository [1000] to one or more clients. The transmission channel [1005] could be wired or wireless, e.g. could be a broadcast channel or an ethernet channel. The client transceiver [1002] receives messages in the channel [1005] and places them in the incoming queue where they are viewable on the client (Inbox [1003]). From Inbox [1003] the messages may be triaged into two or more secondary mailboxes [1004] as described in detail above.

While the client-server interaction described in reference to FIG. 10A allows for no feedback from client to server, the system of FIG. 10B permits complete synchrony between a triage system on the server and its mirror on the server. In the system of FIG. 10B, the primary mailbox [1006] on the server is mirrored to the primary mailbox on the client [1011], and the secondary mailboxes on the server [1007] are mirrored to the corresponding secondary mailboxes [1012] on the client. This mirroring is negotiated over a bi-directional transmission channel [1009] via transceivers [1008] and [1010] on the server side and client side respectively. The mirroring is such that, e.g. if a message is triaged on the client side (moved from the primary mailbox [1011] to a secondary mailbox [1012]) then it is also triaged on the server side (moved from the primary mailbox [1006] to the same secondary mailbox in the plurality of secondary mailboxes [1007]). Similarly, if a message is created on the server (or received from yet another client by the server) in the primary mailbox [1006] it will be transmitted via [1009] so that it appears in the incoming message queue on the client and viewable in mailbox [1011]. In this way, triage in this embodiment occurs both on the client and the server.

### Duplication of UI Element to Thumb-Accessible Regions

Mobile devices are often operated, at least in part, by the thumbs of the hand or hands holding the device. And yet, typical mobile device user interfaces have buttons far removed from the comfortable reach of those thumbs. To operate such a button, the user must let go of holding the device with at least one hand, to be able to reach up to the button. An example is shown in FIG. 11, which shows part of the user interface of the program mail.app from Apple, discussed above in reference to FIG. 1.

In this prior art device, the Cancel and Send buttons, [1101] and [1102] respectively, are at the top of the screen, making them difficult to reach at best, while the device is held near its bottom. For still larger devices, reaching to the top with a thumb while holding the device with the same hand near the bottom may be strictly impossible.

We have already seen, in FIG. 5, an apparatus which makes buttons accessible by duplicating them into a region which is thumb accessible. In particular, the function of the button [506], near the top of the device is duplicated in the function of the button [507], near the bottom of the device. Similarly, the function of the button [505] is duplicated by the button [508]. The general situation is as shown in FIG. 12, to which we now turn.

FIG. 12 shows a device with two thumb-accessible regions [1201] and a thumb inaccessible region [1202], which is the rest of the screen. Thumb-accessible means comfortably accessible by a thumb of a hand holding the device in a preferred location near the bottom of the device, and without letting go of the device with that hand, or substantially changing the user's grip on the device with that hand. Colloquially, where it is not a stretch to perform the gesture. The exact size of the accessible region will depend on the over all size of the device, exactly where and how the device is best held, the size of the hands of the population of target users of the device and so on. Assuming the device is held so that the thumbs pivot from substantially the lower corners of the device, the radius of the thumb accessible regions, centered at those corners, will be about 2 or 3 inches. In devices built according to this aspect of this invention, at least one gesture activatable function, said activatable function being activatable by a gesture in the thumb-inaccessible region of the device, is also activatable by a gesture in the thumb-accessible region of the device.

It need not be the case that the same type of gesture is required to active a function which is activatable in both the thumb-accessible and thumb-inaccessible regions. For instance, it could be that a function activatable by a swipe in the thumb-inaccessible region is also activatable for a tap in the thumb-accessible region, a gesture of a different type. An illustrative non-limiting device having that property is shown in FIG. 13. In this device, a function activated by a swipe in a particular direction and place in the thumb-inaccessible region [1302], indicated by the arrow [1303], could also by activated by tapping on a button [1304] in the thumb-accessible region [1301].

It need not be the case that either or both of the gestures required to activate a function in the thumb-accessible and thumb-inaccessible region be labelled or visually marked to indicate their function. FIG. 14 shows a device illustrating this. In this device, a button [1403] in the thumb inaccessible region [1402] is labeled with the function name “F1”, so that the user understands that pressing the button [1403] will cause the function F1 to be performed. And yet the device of FIG. 14 is configured so that a swipe in either direction in left portion of the thumb-accessible region, indicated by the arrow [1404] also activates the function F1. And yet, the swipe region in this illustrative device is not labeled in any way indicating that it possesses the ability to activate the function F1.

### Thumb-Accessible Function Tray

The thumb-accessible function tray is a mechanism for visually guiding the user to operate one or more functions duplicated from the thumb-inaccessible to thumb-accessible region according to the teachings of this invention. This aspect is illustrated in FIG. 15. In this embodiment, the function tray is a visually marked region residing at least partially in the thumb-accessible region of the device. The thumb-accessible function tray, as seen in this figure, has a high aspect ratio bounding box (generally greater than 2) to indicate the dominant direction in which it is to be swiped (assuming it is swipe sensitive) and yet the narrow dimension is wide enough to contain keys (tappable areas) which are big enough to be tapped by a finger or thumb without undue effort. Even though the thumb-accessible function tray may visually cut across thumb-accessible and thumb-inaccessible regions, duplicative mapping of a gesture from the thumb-inaccessible region to the thumb-accessible tray should be to the intersection of the thumb-accessible function tray with the thumb-accessible region, for at least one such gesture. Then, the tray responds to taps and/or swipes in such a way that at least one of the functions activatable in the thumb-inaccessible region is also activated by a gesture in the tray. For the sake of illustration, the thumb-accessible tray [1503] of the embodiment of FIG. 15 contains an array of buttons at least one of which maps a function from the thumb-inaccessible region [1502] into the thumb-accessible tray [1503], which is largely or wholly contained in the thumb-accessible region [1501], though for the sake of visual continuity may extend partially outside the thumb-accessible region [1501]. in the sense that tapping on said at least one button in the tray [1503] activates a function F1 which could also be activated from outside the tray, in the thumb-inaccessible region [1502]. Specifically, consider a button [1504] in the thumb-inaccessible region [1502] which activates a function F1. It is mapped to a button [1505] the thumb-accessible function tray [1503], at some place where the tray [1503] intersects the thumb-accessible region [1501], and also activates the function F1.

### Various Configuration of the Thumb-Accessible Function Tray

For illustration, the thumb-accessible function tray of the embodiment of FIG. 15 occupies the bottom of the device or display, is contiguous, and spans the width of the device or display. Many other configurations are possible within the scope of this aspect of the invention. Several variants are shown in FIGS. 16A-C. In each panel of FIG. 16, elements are labeled as follows: the thumb-accessible function tray [1603], the thumb-inaccessible region [1602], a button [1604] in the thumb-inaccessible region [1603], a button [1605] in a thumb-accessible region [1601] of the thumb-accessible function tray [1603] where it intersects the thumb-accessible region [1601].

Specifically, FIG. 16A shows the thumb-accessible function tray [1603] in a horizontal orientation, but not at the bottom. In this example it is placed above another UI element, in this case, a keyboard [1606]. In this, as in other embodiments, the thumb-accessible function tray could contain other buttons not duplicating the function of a button in the thumb-inaccessible region [1602]. Such a button is shown in FIG. 16A as [1607]. FIG. 16B shows a thumb-accessible function tray [1603] oriented vertically, and broken into two parts, each part intersecting one of two disjoint regions of the thumb-accessible region [1605]. Especially for large devices, such as tablets, it is to be anticipated that the region accessible by one thumb of a hand holding the device will not overlap with a region accessible by the opposite thumb when that opposite hand is holding the device. In such cases, there could even be buttons in the part of the thumb-inaccessible region [1602] between the non-intersecting parts of the thumb-accessible region [1601]. This is the case for the button [1604] in FIG. 16B. Here, the function of button [1604] is duplicated by a button [1605] in the left part of the thumb-accessible function tray [1603]. Another button in the thumb-inaccessible region such as [1606] could be also mapped to the left part of the thumb-accessible function tray [1603] or to the right part, as it is shown in FIG. 16B, where the button duplicating the function of button [1606] is labeled [1607].

FIG. 16C illustrates that the thumb-accessible function tray [1603] need not be visually represented as a rectangle, but could be represented by any other shape, such as a circle, or a plurality of ovals. Thus FIG. 16C shows the thumb accessible function tray as two ovals, containing a plurality of gesture-sensitive regions (buttons) [1610], some of which duplicate functions activated by gestures in the thumb-inaccessible region [1602].

### Thumb-Accessible Function Tray Responsive to Both Swipes and Taps

It has already been pointed out that when a gesture in the thumb-inaccessible region which activates a given function F is duplicated by a gesture in the thumb-accessible region which activates the same function F, the gesture of the duplicate need not be the same as the gesture of the original. Conceivably a swipe and a tap in the same region could activate different functions. In such a case, it may be difficult or impossible to label the functions so that the user can see both the label for the tap function or the swipe function in the same physical place. In one aspect of the present invention, we particular point out preferred ways to construct devices which address this problem. In these constructions, one or the other sets of labels, one for taps and one for swipes is visually dominant at any one time. The labels for the other set become dominant when the corresponding gesture is initiated.

Turning now to FIG. 17A-B, we will consider a thumb-accessible function tray which responds to both taps and swipes [1703] in a device with a thumb-accessible region [1701] and a thumb-inaccessible region [1702]. For simplicity, we will consider an embodiment with but a single button [1704] activating the function F1 in the inaccessible region [1702] mapped to a button [1705] in the thumb-accessible function tray [1703] also activating the function F1, and a single swipe action in the thumb-accessible function tray [1703], though in general the function tray could contain multiple buttons and respond to multiple swipes in various directions and remain within the scope of this aspect of the present invention. A tap on the button [1705] activates a function F1, and the swipe activates a second function F2. As the tap and the swipe activate different functions, and yet occupy the same physical portion of the device, a problem arises as to how to label that portion, either as F1 or as F2, or neither, since labeling both would cause labels to overlap and be difficult to read. A first solution comprises a default state, shown in FIG. 17A, where the button [1705] is shown, labeled with its function F1. This default state is shown whenever no gestures are being performed in the thumb-accessible function tray [1703], or only taps are being performed. As soon as a swipe in [1703] is initiated, the display changes to that of FIG. 17B, where the display of the button [1705] is suppressed, along with the label F1, to be replaced with a label F2, indicating that the function F2 will be activated if the swipe is completed, perhaps along with an arrow [1706] indicating the direction of the swipe. As soon as the swipe is completed, the display returns to the default state of FIG. 17A. Alternatively, FIG. 17B could be the default state, changing to the display of FIG. 17A when a tap is initiated (key down) on button [1705], and/or on the other buttons, if any, in the function tray [1703].

Order-Preserving Duplication into the Thumb-Accessible Region

We now turn to FIGS. 18A-B to teach order-preserving duplication into the thumb-accessible region. Whether buttons (or other gesture-sensitive elements) are duplicated are arranged in a visually distinct tray in the thumb-accessible region or not, it is possible to map such buttons from the thumb-inaccessible region into the thumb accessible region in such a way as to maintain their order, at least in part. Here, in FIG. 18A, a plurality of buttons [1803]-[1807] in the thumb-inaccessible region [1802] are duplicated into the thumb-accessible region [1801] as buttons [1808]-[1812] respectively in way such as to maintain their relative positions in a horizontal order, and such that the respective duplicate performs the same function as the button it duplicates. That is, if a given first button in the plurality [1803]-[1807] is to the left, respectively right, of a second button in [1803]-[1807] then the duplication of the first in the plurality [1808]-[1812] are also to the left, respectively right of the duplication of the second button in the plurality [1808]-[1812]. In FIG. 18B, the order preservation is vertical, in that if a given first button in the plurality [1803]-[1807] is above, respectively below, a second button in [1803]-[1807], then the duplication of the first button in the plurality [1808]-[1812] is also above, respectively below the duplication of the second button in the plurality [1808]-[1812].

Note that a special case of order-preserving duplication is shown in FIG. 5, a case which we will call perpendicular duplication. In perpendicular duplication, if the region into which buttons are duplicated has a generally horizontal extent, then buttons are dropped directly vertically into that region. If the region receiving the duplications is generally vertically oriented, then the duplications are dropped horizontally from their original location. This is illustrated in FIG. 5 where the button [506] at the top, in the thumb-inaccessible region, is duplicated to the button [507] at the bottom, in the thumb-accessible region, both activating the same function F1. In the same way, button [505] is duplicated from the thumb-inaccessible region to button [508] in the thumb-accessible region, both [505] and [508] activating the same function F2. It is to be further noted that each of said buttons [505-508] is a) isolated, in the sense that there is no other button within a thumbs width of said each button, and b) in or near a corner of the display, “near” in the sense that there exists a corner of the display such that there is no other button which is closer to that corner, and all other corners are at a greater distance from the center of said each button.

### Top to Bottom Tray Perpendicular Duplication

FIG. 5 shows a further aspect: there are two distinct regions containing buttons (what we are calling “trays” in this disclosure), one at the top of the device and another at the bottom. In a device where top-tray buttons are systematically duplicated to bottom-tray buttons, the bottom-tray duplications need not be labeled with the function they perform, or even be visible. The bottom tray itself could be invisible. And yet, the user will be systematically able to find bottom-tray buttons and know their function, given the rule of perpendicular duplication, and that the top-bar button which is duplicated is itself visible and, potentially, labeled.

### Interactions Between a Function Tray and Swipe Switches

We will describe swipe-switches which are “associated” to a (regular) switch. By “associated” we mean that the set of functions of the swipe-switch intersects the set of functions of the switch. That is, at least one action which can be performed by activation of the swipe-switch may also be independently performed by activation of the associated regular switch, and vice versa. In various aspects of the invention, the association of a swipe-switch with its associated regular switch or switches may be made manifest to the user in the physical proximity of the associated switch to the path of the swipe-switch, and/or by joint sensory stimuli such as shared color, shape, pattern, sound, texture and so on between a swipe-switch and its associated switch. So that, even in the case of devices comprising multiple swipe-switches with their associated switches, it is readily appreciated by the user of the device which swipe-switch each associated switch is associated to.

Turning now to FIG. 19, we see an illustrative embodiment of some aspects of the above. FIG. 19 shows an electronic device [1900] comprising a capacitive touch screen [1901], capable of displaying various images and sensitive to gestures by the user. The display shown in FIG. 19 comprises an area for displaying content, such as text [1902] which we will refer to as the text box. It further comprises a keyboard [1903], a function tray [1904], which in turn contains a tappable area (regular switch or “key”) [1905]. The switch [1905] is associated to a swipe switch [1906] in the sense that one of the functions of the swipe switch [1906] is the same as the function activated by tapping the tappable area [1905]. For illustrative example, consider that the swipe switch [1906] performs the following functions: a) when swiped in an upwards direction, it changes the keyboard [1903] to caps mode for the input of a single capital letter, b) when swiped downwards, it locks caps mode, and when swiped up and continuously held in the text box [1902] it keeps the keyboard [1903] in caps mode for as long as the gesture is held. The switch [1905] performs only one of these functions when tapped, for instance the function of changing the keyboard [1903] to caps mode for the entry of a single capital letter. The functional association of the switch [1905] and the swipe switch [1906] is communicated to the user by means of the spatial relationship between the two elements, specifically, that the switch [1905] lies along the path of the associated swipe switch. As we will see below, this relationship can be further stressed by various techniques to be described.

Turning now to FIG. 20, we see an illustrative embodiment with an array of swipe switches a plurality of which are associated to switches in a function tray. FIG. 20 shows an electronic device [2000] comprising a capacitive touch screen [2001], capable of displaying various images and sensitive to gestures by the user. The display shown in FIG. 20 comprises an area for displaying content, such as text [2002] which we will refer to as the text box. It further comprises a keyboard [2003], a function tray [2004], which in turn contains a plurality of tappable areas (regular switches or “keys”) [2005]. Each of the switches [2005] are associated to one of the swipe switches in the array of swipe switches [2006], in the sense that one of the functions of each of the swipe switches in the array [2006] which is associated to one of the switches in the plurality [2005] is the same as the function activated by tapping the associated tappable area in the associated member of the plurality [2005]. As in the case of FIG. 19, the association of a swipe switch to its respective switch is manifest not only by the sharing of a function between the two, but also by spatial proximity and alignment. In this case, the ideal path of each of the swipe switches terminates in its associated switch in the function tray [2004].

In addition to or instead of signaling the association of a switch to a swipe switch by means of spatial relationship, the swipe-switch and its associated switch(es) might also emit the same sound when activated to perform the function they share. The ideal path of the swipe switch could also have the same color or be decorated in the same pattern as its associated switch. An example of the latter is shown in FIG. 21, to which we now turn.

The electronic device [2100] of FIG. 21 has generally the same elements as the electronic device of FIG. 20, namely, a capacitive touch screen [2101], capable of displaying various images and sensitive to gestures by the user, a text box [2102], a keyboard [2103], a function tray [2104], which in turn contains a plurality of keys [2105]. Each of the keys [2105] is associated to one of the swipe switches in the array of swipe switches [2106], in the sense that one of the functions of each of the swipe switches in the array [2106] which is associated to one of the switches in the plurality [2105] is the same as the function activated by tapping the associated tappable area in the associated member of the plurality [2105]. In FIG. 21, the associate of each swipe switch to its associated switch is marked not only by the spatial relationship of the two, they are also paired by means of colors, the colors represented in FIG. 21 by various patterns.

The sharing of a function between swipe switch and switch as discussed above provides a partial redundancy to the user interface. This redundancy is helpful for novice users who may be familiar with tapping a key to active a function, but not familiar with activating a swipe switch. Once they have learned to associate switch with its swipe switch, and understood that the switch is in fact unnecessary to obtain the function shared between switch and swipe switch, the function tray containing the associated switches can, in this aspect of the invention, be hidden. This is shown in FIG. 22 to which we now turn.

FIG. 22 shows the state of the system of FIG. 21 when the function tray is hidden. Specifically, the electronic device [2200] of FIG. 22 comprises a capacitive touch screen [2201], in turn comprising a text box [2202], a keyboard [2203], and an array of swipe switches [2206]. A plurality of the swipe switches in the array of [2206] are distinctively colored or patterned. With the function tray hidden, the screen real estate it occupied can be deployed elsewhere, for example used to make the keys of the keyboard [2203] larger or more numerous.

### Independent Function Tray

When a large part or even the entirety of a device is thumb accessible, having dual mechanisms for the user to activate a function, one in the function tray and one outside of it, may be unwarranted. This, despite the advantageous flexibility of dual mechanisms, in particular provide the ability to label one of the mechanisms, while suppressing the label of the other mechanism. In the aspect of these teachings to be illustrated in this section, this flexibility is brutally sacrificed, by containing most if not all tappable and swipeable areas in a single independent function tray, preferably at the edge of the display. The function tray in this context retains the qualities of visually defined area of high aspect ratio suggesting a direction of swipe, and yet even in the narrow dimension it is wide enough to support effectively tappable areas, which, since most if not all of the device is in the thumb accessible region, the function tray is necessarily thumb accessible.

An embodiment of this inventive concept will now be described in reference to FIGS. 23A-C. Turning first to FIG. 23A, We see that this embodiment concerns an illustratively small device [2300], smaller even than the thumb accessible region [2300]. Such a device might be, for example, a wristwatch-sized device comprising a touch screen [2302]. The device [2301] displays on its touchscreen [2302] a function tray [2303] along the bottom of the screen. As described in more detail in relationship to embodiments discussed above, the function tray of FIGS. 23A-C may be responsive to either or both of taps and swipes along its length. The labeling of the tray may be context sensitive, in that it generally depends on whether a swipe or a tap, or neither, is being performed on the function tray at any given moment. More generally, the labeling of the function tray and the functions it can perform depend on the state of the system.

An illustrative example of system state dependence of the function tray is described in relationship to FIGS. 23A-C. In this illustrative example, swipes along the length of the function tray are uses to navigate “pages” or “screens” of content. There are several tappable regions in the function tray [2304]-[2305], the functions of which change depending which page is currently displayed.

In FIG. 23A, the region of the display other than that occupied by the function tray [2303] displays the content of a first page, schematically denoted as a rectangle [2307]. On the first page, the tappable region [2304] performs one function, F1, and the tappable region [2305] performs a function F2, potentially the same function F1. In the middle of the function tray [2303] are displayed navigation dots [2306], used to indicate to the user which page they are on. In this embodiment, the fact that the function tray [2303] is swipeable, and that swiping serves to change the page, is not otherwise indicated to the user, though it could be in other embodiments, e.g. by the addition of displayed arrows. FIG. 23A shows the function tray [2303] in the resting state, that is, when neither taps or swipes are being executed in the function tray [2303]. Though not shown in FIG. 23A, while the function tray is swiped, the display on the function tray changes, so that the display of a marking indicating the position of the tappable regions is suppressed, as are the navigation dots [2306]. During the swipe, the resting-state display is replaced by another display indicating that when the swipe is completed, the page will change. For a short time after the page has changed, the navigation dots are preferably replaced by a label naming the current page, where that name is display for a brief period after the change has occurred. This is described in more detail in reference to FIG. 23B to which we now turn.

FIG. 23B shows the state of the system for a brief period after the page has changed. During this brief period, the state of the system is the same as in FIG. 23A except, a) there is an indicator in the function tray [2303] that the page has changed, via a label [2309] illustratively “Page 2”, b) the tappable regions [2304] and [2305] may have changed functions to F3 and F4 respectively, which may or may not be identical to each other or to the functions F1 and F2, with label changes in the tappable regions [2304] and [2305] accordingly, and c) the content of the rest of the page [2308] has changed.

FIG. 23C shows the state of the system after the transitional brief period. Now the label [2309] of FIG. 23B has been replaced with navigation dots [2310], labeled to indicate that the state of the system is the state appropriate to “Page 2”.

In view of embodiments discussed above, the person skilled in the art will appreciate that the function tray could be aligned along other edges than the bottom edge as well.

### Smart Bezels

A device comprising a touch screen also comprises some sort of mounting for the touch screen. In typical such devices, the mounting, or bezel is made as thin as possible so that the touch screen area can be as large as possible given the overall size of the device. Even for very thin bezels, as it is pointed out in the aspect of the present invention described in this section, the bezel can contribute to the user-controllable aspects of the device.

While the touch screen itself must be both sensitive to user gestures such as touches and swipes, it must also be capable of displaying changeable images. These dual requirements limit the structural strength of the materials employed in the touch screen, necessitating a bezel of a stronger material. By eliminating the second requirement, the ability to display changing images, capacitive materials such as metals or certain kinds of plastics can be used to both capture gesture information, and mechanically support the touch screen. Many such so-called smart materials currently exist, and developing new ones is an area of active research, as will be appreciated by one skilled in the art. Surprisingly, working in concert with the touch screen itself, such “smart bezels” can measurably increase the gesture-sensitive area. Such increase in gesture sensitive area becomes of much increased importance as the overall size of the device becomes small, as in the embodiments discussed above contained largely or entirely in the thumb-accessible region. In a further surprise, even a non-gesture sensitive bezel material can be made to improve the ability of the device to be operable by gestures, by shaping the surface to be perceptibly different to the touch, depending on where it is touched.

We first consider the application of smart bezels which are not necessarily capable of capacitive sensing, that is not capable of generating an electrical signal in response to being touched by the user processable into a control signal for the device. This embodiment, discussed in reference to FIG. 24, comprises a touch screen [2401] and a bezel [2402]. In at least one state of the device, a keyboard [2403] is displayed on the touch screen [2401] such that some (in this case all) of the keys of the keyboard share at least one edge with the bezel [2402]. For instance, keys [2408] and [2409] each share two edges with the bezel [2402]. Especially when the keys are small (due especially to the entire device being small), there is a good chance that the finger or thumb used to tap the keys will also tap the bezel. Markings [2404]-[2407] are inscribed in the bezel which create a texture perceptible to the touch. That is, when the user taps the key/bezel area, they can sense that they are on the bezel, in part. This sensation supplies orientation information which improves the accuracy with the keys can be hit, and/or the confidence of the user that they have hit the intended key, since each key is associated to a physical texture. The accuracy and/or confidence of the user can be further improved if the texture of the bezel adjacent to each key is different. In this illustrative non-limiting embodiment, each of the keys is adjacent to a portion of the bezel with a perceptibly different texture, signaling to the user the identity of the key which was hit. Even if the keys are large enough so that the bezel is only occasionally hit when the keys are tapped, the textures can supply sufficient orientation information to increase accuracy and/or confidence while the keyboard is being used.

If the bezel [2402] in additional to being textured, is smart enough to also be capable of generating a control signal in response to the tapping gestures, then the accuracy can be further improved. That is, the control signal from the bezel can be electronically combined with the control signal from the keys, so as to provide information for error correction or other data processing with the goal of determining which key the user intended to hit.

Turning now to FIG. 25, we describe the use of a smart bezel in conjunction with a function tray such as used in various embodiments above. In the device of FIG. 25, there is a smart bezel [2502] and a touch screen [2501]. In at least some states of the device, there is displayed a function tray [2503], which is both swipeable and tappable. For illustration, two tappable areas [2504] and [2505] are shown. Each of these tappable areas are adjacent to the smart bezel, in these cases, along two edges, both a side and the bottom. In addition, a swipe along the length of the function tray will also be along the bezel, always or occasionally, depending on the size of the device. Since the texture of the bezel in this embodiment is perceptible to the touch as being different from the texture of the touch screen, the bezel provides orientation information to the user. Since, in this embodiment, the smart bezel is also capable of generating electrical signals in response to taps and swipes, the effective usable area of the function tray is increased. That is, the area of the smart bezel [2502] indicated by the pattern [2508] is sensitive to swipes and taps and the areas [2506] and [2507] are sensitive (at least) to taps. When each of the regions [2506]-[2507] are distinctively textured so as to be recognizable by touch, the accuracy and usability of the device is further improved.

It is stressed that when the device is quite small, this extension of the gesture-sensitive area of the device could have a dramatic effect on the usability of the device.

Turning now to FIG. 26, we point out that the two embodiments just described, involving a keyboard and function tray respectively, could be combined. FIG. 26 contains both a keyboard [2609] and a function tray [2603] displayed in a touch screen [2601]. All of a) the keys of the keyboard [2609], b) the tappable areas of the function tray [2604]-[2605], and c) the swipeable area of the function tray [2603] (its entire length in this embodiment) share at least one edge with the smart bezel [2602]. Portions of the smart bezel are distinctively textured and/or gesture sensitive so as to allow the user to identify features of the touch screen by touch, these distinct portions are [2606]-[2608] relating to the function tray [2603], and [2610]-[2613] relating to the keyboard [2609]. Thus, all of these elements benefit from the extension of the gesture sensitive area provided by the smart bezel.

It is to be appreciated that all the non-limiting embodiments presented above are meant to illustrate various aspects and features of the present invention, the scope of which is to be determined solely from the appended claims. It is particularly pointed out that though we have mentioned “watches” as a possible application for some aspects of these teachings, other settings are well within the scope of the present invention, including phones or other communication devices, pendants, finger rings, eye glasses, other “wearable computing” devices, and so on.

What is claimed is:

1) A device for message triage comprising
a) a display,
b) a plurality of gesture-sensitive regions, each said gesture-sensitive region capable of activating one or more functions of said device when a user of said device makes a gesture recognized by said each said gesture-sensitive region,
c) a central processing unit,
d) a wired or wireless conduit for receiving electronic messages,
e) circuitry for rendering said electronic messages in human-readable form for display on said display,
f) a queue for untriaged messages, q0,
g) at least two queues, q1, q2, . . . for triaged messages,
h) a user interface sensitive to moving gestures, said moving gestures being gestures recognized by one or more of said gesture-sensitive regions such as to activate movement of a message from one of said queues to another, such that for each of said queue q1, q2, . . . , there exists at least one said moving gestures which moves a message from said queue of untriaged messages, q0, to said each of said queues, q1, q2, . . . , and also removes said moved message from said queue of untriaged messages, q0.

2) The device of claim 1 where said messages are email messages.

3) The device of claim 1 where said moving gesture to move a message from said q0 to said q1 is a first swipe and said moving gesture to move a message to q2 is a second swipe in the opposite direction of said first swipe.

4) The device of claim 1 where at least one of said moving gestures is a tap on an button at or near one of the four corners of said display.

5) The device of claim 1 where q1 is a queue of deleted messages and q2 is a queue of messages to be potentially further treated later.

6) The device of claim 1 where at least one of said moving gestures has a difficulty measure of (2,0) or less.

7) The device of claim 1 where at least one of said moving gestures has a difficult measure of (1,0) or less.

8) The device of claim 1 where at least one of said queues contains messages which have been replied to.

9) The device of claim 1 where replying to a message and resetting said system for reply to another message requires a total difficulty of less than 3, excluding the difficulty of typing the reply message.

10) The device of claim 1 where said messages are displayed one by one in order of chronological or reverse chronological order of receipt, permitting deleting or saving for later treatment to be accomplished by one gesture and no selection, and replying to or forwarding a message requires only two gestures, excluding any gestures related to typing.

11) The device of claim 1 further comprising voice-recognition hardware and software such that at least one of said one or more functions activated by said gesture-sensitive regions may also be activated by voice.

12) The device of claim 1 where, with a difficulty measure of no more than (2,0) to complete any triaging action, said triaging actions comprising replying, deleting and saving for later, said messages can be rapidly triaged into said queues comprising three said queues q1, q2, and q3, said messages being automatically moved to said q1 after being replied to while in said q0, q2 designated as a said queue for said messages which are to be archived or subject to further treatment, said messages moving from said q0 to said q2 as the result of a said moving gesture, and said q3 designated as a said queue for messages to be deleted or otherwise abandoned, said messages moving from said queue q0 to said queue q3 as the result of a said moving gesture.

13) The device of claim 13 where said triaging actions also include a forwarding action, and where messages which are forwarded are automatically moved to said q1 after said forwarding.

14) The device of claim 1 where one or more queues are associated with time information, permitting said messages to be associated to a calendar or a todo list.

15) A device comprising thumb-accessible and thumb-inaccessible regions, each of said thumb-accessible and said thumb-inaccessible regions comprising at least one gesture-sensitive region, such that at least one said gesture-sensitive region in said thumb-inaccessible region activates a function F1 and at least one corresponding said gesture-sensitive region in said thumb-accessible region also activates said function F1.

16) A device comprising a touch screen, said touch screen capable of obtaining a state in which an independent tappable and swipeable function tray along the bottom edge of said touch screen, contained mainly within the thumb-accessible region of said device.

17) The device of claim 20 further comprising an array of swipe switches, a plurality of which is associated to a tappable area in a function tray, and each member of the plurality thus associated shares a function with its associated tappable area.

18) A device comprising a touch screen and an associated smart bezel, such that swipes or taps near the edge of said touch screen may also be processed by said smart bezel.
